(19) United States
(12) Patent Application Publication
(10) Pub. No.: US 2026/0318542 A1
(43) Pub. Date: Oct. 15, 2026

(54) COOKING APPARATUS

(71) Applicant: LG Electronics Inc., Seoul (KR)

(72) Inventors: Eunjung SHIN, Seoul (KR); Hyeunsik NAM, Seoul (KR); Junghyeon CHO, Seoul (KR); Soon Do HONG, Seoul (KR)

(73) Assignee: LG Electronics Inc., Seoul (KR)

(21) Appl. No.: 19/485,217

(22) PCT Filed: Nov. 1, 2024
(86) PCT No.: PCT/KR2024/017006

§ 371 Date: Nov. 17, 2025

(30) Foreign Application Priority Data
Nov. 9, 2023 (KR) 10-2023-0154884

(51) Int. Cl. F24C 7/08; H05B 1/02

(52) U.S. Cl. CPC F24C 7/087; H05B 1/0225; H05B 1/0266

(57) ABSTRACT

The present invention relates to a cooking apparatus, which generates a heat output lower than that of a selected low power level when a user inputs, while a heating unit is heating a container at a high power level, an operation for changing an output level to a low power level with a significantly large output difference therefrom, and thus can remarkably reduce the possibility of overcooking of food kept in the container.

### TECHNICAL FIELD

The present disclosure relates to a cooking appliance, and more specifically, to a cooking appliance configured such that in response to that while a heating unit heats a container at a high heating power level, a user's manipulation of changing an output level from the high heating power level to a low heating power level having a considerably large difference from the high heating power level is inputted, the thermal output level lower than the selected low heating power level is generated, thereby remarkably lowering the possibility of overcooking food stored in the container.

### BACKGROUND ART

A cooking appliance refers to a type of a home appliance for cooking food, and is an apparatus installed in a kitchen space to cook food according to a user's intention.

Such cooking appliances may be classified in various ways based on a type or a form of a used heat source, and a type of a fuel.

Among such cooking appliances, a cooktop in which an object to be cooked is placed thereon and is heated using a heat source disposed under is used.

The cooktops may be classified into a cooktop including a gas type heater using gas combustion, a cooktop including a radiant type heater using heat generation of an electric heater, a cooktop including an induction type heater operating in an induction heating manner, etc. according to the type of the heat source.

In particular, the cooktop including each of the radiant type heater and the induction type heater may have a structure capable of preventing direct exposure to a heat source, and have an excellent outer appearance compared to the cooktop including the gas type heater, and may not generate the combustion gas and thus is preferred by a user.

In this regard, U.S. Pat. No. 11,536,460 (prior document 001) discloses a cooking appliance including the radiant type heater.

The heater of the cooking appliance disclosed in Prior Document 001 includes a heating coil provided as a resistance heating element, and a container-shaped thermal insulator for accommodating the heating coil therein, wherein the heat generated from the heating coil is transferred to a top plate and then transferred to the container so that food stored in the container may be cooked.

### DISCLOSURE

### Technical Purpose

The cooking appliance disclosed in the prior art document 001 as described above is configured such that in response to that when a user's manipulation of changing a thermal output level is input while the container is being heated at a high heating power level, a thermal output corresponding to the selected output level is generated, regardless of the current temperature of the container and the current temperature of the heating unit.

Therefore, the cooking appliance disclosed in Prior Document 001 has a problem in that even when the operation of the heating unit is changed to the operation at the low heating power level during the operation at the high heating power level, the temperature of the container is not immediately lowered to the temperature corresponding to the low heating power level due to the thermal inertia of the heating unit having the radiant type heater but rather the temperature of the container continuously increases, such that there is a very high possibility of unintended overcooking of food stored in the container.

In addition, in the cooking appliance disclosed in the prior art document 001, even after the output level is changed to the lower output level, the temperature of the container is continuously increased. However, the thermal output corresponding to the low heating power level is to be continuously generated. This may lead to power loss, and thus, there is a problem in that the power efficiency of the heating coil is very likely to deteriorate.

A first purpose of the present disclosure is to provide a cooking appliance configured such that in response to that while a heating unit heats a container at a high heating power level, a user's manipulation of changing an output level from the high heating power level to a low heating power level having a considerably large difference from the high heating power level is inputted, the thermal output level lower than the selected low heating power level is generated, thereby remarkably lowering the possibility of overcooking food stored in the container.

In addition, a second purpose of the present disclosure is to provide a cooking appliance capable of effectively preventing power loss and deterioration of power efficiency of a heating coil, which may be caused in a situation in which even after the output level has been changed to the lower level, the temperature of the container is continuously increased but the thermal output corresponding to the low heating power level is generated.

The purposes of the present disclosure are not limited to the above-mentioned purposes, and other purposes and advantages of the present disclosure that are not mentioned may be understood based on the following descriptions, and will be more clearly understood based on the embodiments of the present disclosure. In addition, it will be readily appreciated that the purposes and advantages of the present disclosure may be realized by means indicated in the claims and combinations thereof.

### Technical Solution

A cooking appliance according to the present disclosure may include a heating unit including a heating coil configured to generate heat in an electric resistance manner upon receiving electric power; and a controller configured to control the electric power to be supplied to the heating coil, wherein the controller may be configured to: supply an electric power level corresponding to a first selected heating power level to the heating coil such that an operation of the heating unit is started; and in response to receiving a switching signal of an operation of the heating unit for switching the first selected heating power level to a second selected heating power level lower than the first selected heating power level, supply an electric power level lower than an electric power level corresponding to the second selected heating power level to the heating coil.

Furthermore, the controller may be further configured to: before supplying the electric power level lower than the electric power level corresponding to the second selected heating power level to the heating coil, determine whether the first selected heating power level exceeds a predetermined first set heating power level; and upon determination that the first selected heating power level is greater than or equal to the predetermined first set heating power level, determining whether the second selected heating power level exceeds a predetermined second set heating power level.

Furthermore, the controller may be further configured to: upon determining that the second selected heating power level is lower than or equal to the predetermined second set heating power level, supply the electric power level lower than the electric power level corresponding to the second selected heating power level to the heating coil.

In addition, the predetermined first set heating power level may be in a range of 55% to 65% of the maximum heating power level of the heating unit, and the predetermined second set heating power level may be in a range of 35% to 45% of the maximum heating power level of the heating unit.

Furthermore, the controller may be further configured to: upon determination that the first selected heating power level is lower than the predetermined first set heating power level, supply the electric power level corresponding to the second selected heating power level to the heating coil.

Furthermore, the controller may be further configured to divide a heating power range of the heating coil from a maximum heating power level to a minimum heating power level into a plurality of output levels, and to supply an electric power level corresponding to one selected from among the plurality of output levels, wherein the supplying of the electric power level lower than the electric power level corresponding to the second selected heating power level to the heating coil may include: supplying, to the heating coil, an electric power level corresponding to an output level lower than the output level of the second selected heating power level.

Furthermore, the output level lower than the output level of the second selected heating power level is lower by one level than the output level of the second selected heating power level.

Furthermore, the supplying of the electric power level lower than the electric power level corresponding to the second selected heating power level to the heating coil may further include: determining whether an elapsed time duration from a time-point at which the electric power level corresponding to the output level lower than the output level of the second selected heating power level starts to be supplied to the heating coil reaches a predetermined first set time duration.

Furthermore, the controller may be further configured to: upon determination that the elapsed time duration has reached the predetermined first set time duration, supply the electric power level corresponding to the second selected heating power level to the heating coil.

Furthermore, the supplying of the electric power level lower than the electric power level corresponding to the second selected heating power level to the heating coil may include: cutting off the electric power supplied to the heating coil.

Furthermore, the supplying of the electric power level lower than the electric power level corresponding to the second selected heating power level to the heating coil may further include: determining whether an elapsed time duration from a time-point at which the electric power supplied to the heating coil is cut off reaches a predetermined second set time duration.

Furthermore, the controller may be further configured to: upon determination that the elapsed time duration has reached the predetermined second set time duration, supply the electric power level corresponding to the second selected heating power level to the heating coil.

Furthermore, the supplying of the electric power level lower than the electric power level corresponding to the second selected heating power level to the heating coil may further include: multiplying the electric power level corresponding to the second selected heating power level by a predetermined adjustment coefficient to calculate a lowered electric power level and supplying the calculated lowered electric power level to the heating coil.

In addition, the predetermined adjustment coefficient may be in a range of 0.48 to 0.52.

Furthermore, the supplying of the electric power level lower than the electric power level corresponding to the second selected heating power level to the heating coil may further include: determining whether an elapsed time duration from a time-point at which the lowered electric power level starts to be supplied to the heating coil reaches a predetermined third set time duration.

Furthermore, the controller may be further configured to: upon determination that the elapsed time duration has reached the predetermined third set time duration, supply the electric power level corresponding to the second selected heating power level to the heating coil.

Furthermore, the supplying of the electric power level lower than the electric power level corresponding to the second selected heating power level to the heating coil may include: supplying, to the heating coil, an adjusted electric power level preset to be lower than the electric power level corresponding to the second selected heating power level.

In addition, the preset adjusted electric power level may be in a range of 180 W to 220 W.

Furthermore, the supplying of the electric power level lower than the electric power level corresponding to the second selected heating power level to the heating coil may further include: determining whether an elapsed time duration from a time-point at which the adjusted electric power level starts to be supplied to the heating coil reaches a predetermined fourth set time duration.

Furthermore, the controller may be further configured to: upon determination that the elapsed time duration has reached the predetermined fourth set time duration, supply the electric power level corresponding to the second selected heating power level to the heating coil.

### Technical Effect

The cooking appliance according to the present disclosure may be configured such that in response to that while a heating unit heats a container at a high heating power level, a user's manipulation of changing an output level from the high heating power level to a low heating power level having a considerably large difference from the high heating power level is inputted, the thermal output level lower than the selected low heating power level is generated, thereby remarkably lowering the possibility of overcooking food stored in the container.

In addition, the cooking appliance according to the present disclosure may be capable of effectively preventing power loss and deterioration of power efficiency of the heating coil, which may be caused in a situation in which even after the output level has been changed to the lower level, the temperature of the container is continuously increased but the thermal output corresponding to the low heating power level is generated.

In addition to the above-described effects, specific effects of the present disclosure will be described together while describing specific matters for implementing the present disclosure.

### BRIEF DESCRIPTION OF DRAWINGS

FIG. 1 is a front perspective view of a cooking appliance according to an embodiment of the present disclosure.

FIG. 2 is an exploded perspective view of the cooktop illustrated in FIG. 1.

FIGS. 3 and 4 are a perspective view and a bottom view of the heating unit constituting the cooktop shown in FIG. 2.

FIG. 5 is an exploded perspective view of the heating unit shown in FIG. 3.

FIG. 6 is a front view of a knob constituting a manipulator illustrated in FIG. 1, and is a front view illustrating a state in which a rotation manipulation for selecting a heating power level represented as an output level is input.

FIG. 7 is a graph illustrating a time-dependent temperature change of a container heated by a cooktop of a cooking appliance according to the related art.

FIG. 8 is a graph illustrating a time-dependent temperature change of a container heated by a cooktop of a cooking appliance according to an embodiment of the present disclosure.

FIG. 9 is a front view of a knob showing a configuration in which a heating power level is presented in a different manner from a manner in which a heating power level is presented in FIG. 6.

FIG. 10 is a functional block diagram illustrating a configuration of a controller provided in a cooking appliance according to an embodiment of the present disclosure.

FIGS. 11 to 15 are flowcharts illustrating a method of controlling a cooking appliance according to an embodiment of the present disclosure.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, upon determination that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, etc. are used to describe various components, these components are not limited by these terms. These terms are merely used to distinguish one component from another component. Thus, unless specifically stated to the contrary, the first component may be the second component.

As used herein, unless otherwise stated, each component may be provided as one or more components.

Hereinafter, a first component being disposed “on top of (or under)” a second component may mean that the first component may be disposed in contact with a top surface (or a bottom surface) of the second component, as well as a third component may be interposed between the second component and the first component disposed “on top of (or under)” the second component.

Furthermore, when a first component is described as being “connected” or “coupled” to a second component, the components may be directly connected or coupled to each other, but a third component may be “interposed” between the components or the components may be “connected” or “coupled” to each other via the third components.

As used herein, the singular constitutes “a” and “an” are intended to include the plural constitutes as well, unless the context clearly indicates otherwise. In this application, terms such as “composed of” or “include” should not be construed as necessarily including all of various components or operations described herein, but should be construed that some components or operations among those may not be included or additional components or operations may be further included.

As used herein, the singular constitutes “a” and “an” are intended to include the plural constitutes as well, unless the context clearly indicates otherwise. In this application, terms such as “composed of” or “include” should not be construed as necessarily including all of various components or operations described herein, but should be construed that some components or operations among those may not be included or additional components or operations may be further included.

Throughout the present document, “A and/or B” means A, B, or A and B, unless otherwise specified, and “C to D” means equal to or greater than C and equal to or smaller than D unless otherwise specified.

Hereinafter, the present disclosure will be described with reference to drawings showing a configuration according to an embodiment of the present disclosure.

### Overall Structure of Cooking Appliance

Hereinafter, an overall structure of a cooking appliance 1 according to an embodiment of the present disclosure will be described in detail with reference to the accompanying drawings.

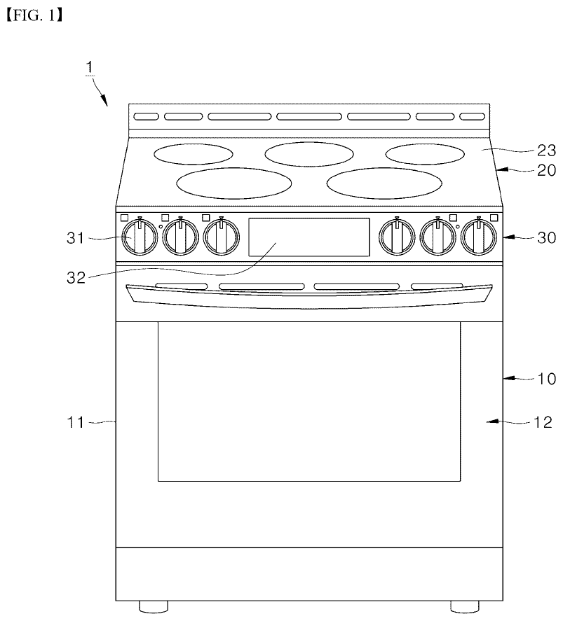

FIG. 1 is a front view of the cooking appliance 1 according to an embodiment of the present disclosure.

Referring to FIG. 1, the cooking appliance 1 according to an embodiment of the present disclosure may include a cooktop 20 and an oven 10.

As illustrated, the cooktop 20 may be disposed on top of the oven 10, and the oven 10 may constitute a lower portion of the cooking appliance 1.

Each of the cooktop 20 and the oven 10 may be provided to constitute the cooking appliance 1 alone, and may be mounted in a built-in manner in a furniture cabinet such as a sink or may be disposed in a freestanding type.

In one example, the present disclosure will be described below in detail with reference to a structure of a multi-functional cooking appliance in which the cooktop 20 is disposed on top of the oven 10 and the cooktop and the oven are integrated with each other. However, the present disclosure is not limited thereto.

The oven 10 may include a main body 11 having a cavity having an open front surface, and a door 12 pivotably connected to the main body 11 to open and close the cavity.

The cavity has a cooking space defined therein, and various types of heating sources such as a heater or a burner are disposed therein to heat the cooking space to cook food.

In the cooktop 20 disposed on top of the oven 10, a container (not shown) containing food to be cooked may be seated on a top plate 23, and a heating unit 22 disposed under the top plate 23 may indirectly heat the container through the top plate 23.

In addition, the cooking appliance 1 may further include a manipulator 30.

As illustrated, the manipulator 30 may include a plurality of knobs 31, and may control operations of the oven 10 and the cooktop 20.

In addition, if necessary, the manipulator 30 may be embodied as a button, a switch, or a touch manipulation device.

As illustrated, the manipulator 30 may be disposed on a front surface of the cooktop 20 or may be disposed on a front surface of the oven 10.

In addition, a display 32 for visually displaying an operating state of the cooking appliance 1 may be provided in proximity to the manipulator 30.

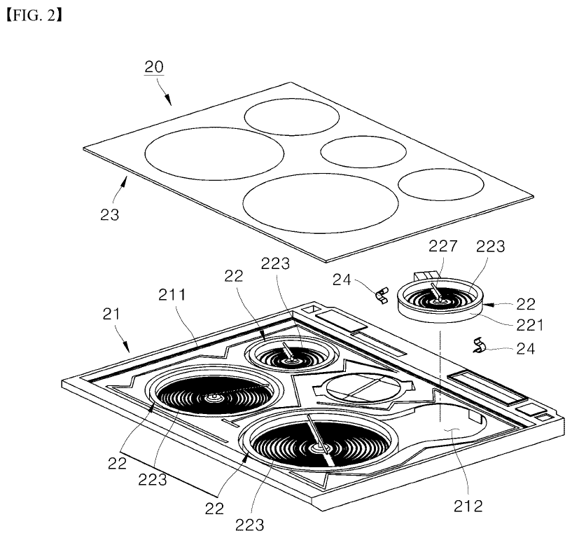

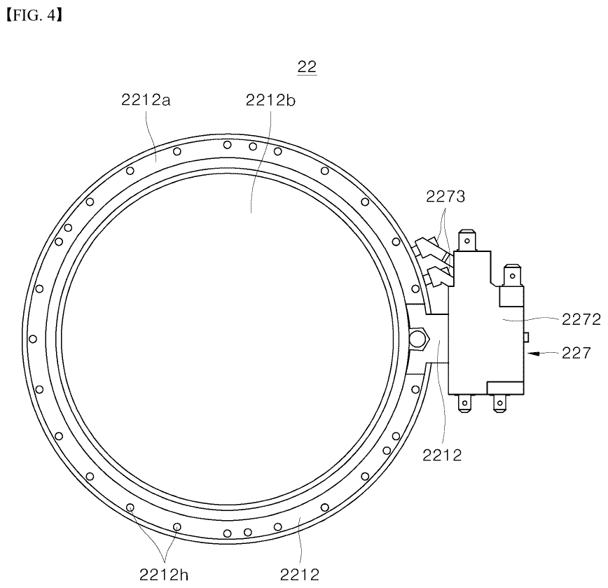

Hereinafter, a detailed structure of the cooktop 20 will be described in detail with reference to FIGS. 2 to 5.

FIG. 2 is an exploded perspective view illustrating the cooktop 20 according to an embodiment of the present disclosure.

As illustrated, the cooktop 20 may include the top plate 23 on which the container is seated, the heating unit 22 disposed under the top plate 23, and a base plate 21 supporting the heating unit 22 and the top plate 23.

The base plate 21 may be formed to have a general rectangular outer appearance, and may define an overall structure of the cooktop 20 and function as a frame capable of supporting the heating unit 22 and the top plate 23.

As illustrated, the base plate 21 may provide a structure in which the heating unit 22 and the top plate 23 may be mounted.

To this end, the base plate 21 may be formed by processing a metal plate so as to have a predetermined rigidity and minimize the influence of heat generated from the heating unit 22.

In a type in which the cooktop 20 is independently installed, the base plate 21 may constitute the outer appearance of the remaining portions except for the upper surface of the cooktop 20. In this case, the base plate 21 may constitute the outer appearance of the cooktop 20, and thus may also be referred to as a casing.

A heating unit receiving hole 212 receiving the heating unit 22 therein may be formed to extend through the base plate 21 in the up-down direction. The heating unit 22 may be disposed in such a manner that the heating unit passes through the heating unit receiving hole 212 and is partially inserted into the heating unit receiving hole 212.

In this regard, the heating unit 22 may be connected to the heating unit receiving hole 212 via a plurality of springs 24 so that an amount of heat generated from the heating unit 22 and transferred to the base plate 21 may be minimized, and the heating unit 22 may be elastically supported. Although FIG. 2 illustrates a configuration in which the heating unit 22 is elastically supported using a pair of springs 24, this is only an example, and the number of springs 24 may be adjusted to vary according to the size or weight of the heating unit 22 As will be described later, a plurality of fastening holes 2212h may be formed in the bottom surface portion 2212 of the casing 221 of the heating unit 22 so that each of the springs 24 may be fixed to each of the plurality of fastening holes.

The cooktop 20 may be provided with a plurality of heating units 22. When the plurality of heating units 22 are provided as described above, a plurality of heating unit receiving holes 212 may be formed to extend through the base plate 21 in a corresponding manner to the plurality of heating units 22.

The top plate 23 may be mounted onto the base plate 21.

The top plate 23 defines the upper surface of the cooktop 20, and an open upper surface of the heating unit 22 may be shielded with the top plate 23 in a state in which the top plate is mounted onto the base plate 21.

In order to mount the top plate 23, a top plate receiving space 211 may be formed so as to be recessed downwards into the base plate 21. The top plate receiving space 211 may be recessed to have a size corresponding to that of the top plate 23.

In addition, a recessed depth of the top plate receiving space 211 may correspond to a thickness of the top plate 23. In this regard, as illustrated, the plurality of heating unit receiving holes 212 may be located in an inner area of the top plate receiving space 211.

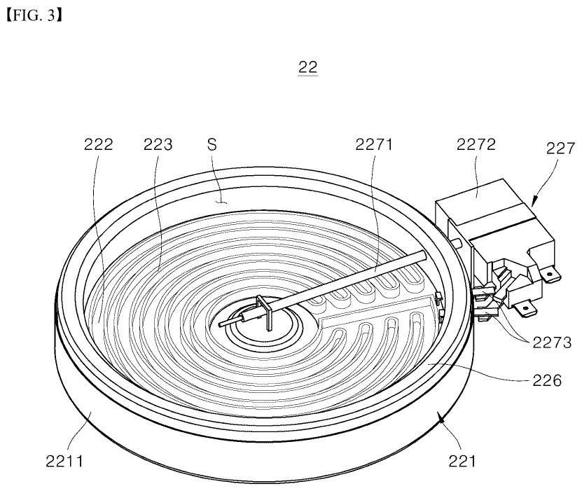

In FIGS. 3 to 5, a detailed configuration of the individual heating units 22 constituting the cooktop 20 is illustrated.

As described above, the heating unit 22 may be elastically fixed and mounted to the base plate 21 via the spring 24 in such a way that the heating unit passes through the heating unit receiving hole 212 and is partially inserted into the heating unit receiving hole 212.

The heating unit 22 functions to directly or indirectly heat the container placed on the upper surface of the top plate 23, and may be variously configured according to the type of the heat source. Accordingly, the heating unit 22 may be referred to as a heater or a burner.

The heating unit 22 may be embodied as one of a closed type heater, a radiant type heater, or an induction type heater according to a heat source.

FIGS. 3 to 5 illustrate an example of a configuration of the heating unit 22 embodied as the radiant type heater that generates heat using an electric resistor. Hereinafter, the present disclosure will be described based on the configuration as shown in which the heating unit 22 is embodied as the radiant type heater.

The heating unit 22 may include a heating coil 223 that generates heat when power is supplied thereto from a power supply 40 to be described later, a thermal insulator 222 and 226 on which the heating coil 223 is seated, and the casing 221 coupled to an outer side surface of the thermal insulator 222 and 226 to protect the thermal insulator 222 and 226 and the heating coil 223.

The heating coil 223 performs a function of generating high-temperature heat on receiving the electrical power from the power supply.

In this regard, heat generated from the heating coil 223 may pass through the top plate 23 and be transferred to the container in a radiation or conduction manner to heat the container.

The heating coil 223 may be configured to generate heat in an electric resistance manner, and may be wound a plurality of times to have circular shapes having different inner diameters.

More specifically, as illustrated in FIGS. 3 to 5, the heating coil 223 is not formed in a perfect circular shape, but may have a general circular shape.

The heating coil 223 may be repeatedly bent in order to maximize the surface area to increase the heating amount to the maximum level.

In one example, the heating coil 223 may be repeatedly bent in a zigzag shape in a top view, and may extend to have a general circular ring shape.

In addition, in order to maximize the amount of the heat generated therefrom, the heating coil 223 may be constructed such that circular ring shapes having different diameters and having concentricity are arranged in a radial manner.

In one example, the heating coil 223 may be divided into an inner coil 224 and an outer coil 225. Accordingly, the amount of heat for heating the container may be adjusted according to a combination of the on/off operations of the inner coil 224 and the outer coil 225.

As will be described later, an electric power level corresponding to a heating power level selected via the manipulator 30 is supplied to the heating coil 223 through the power supply 40, so that the thermal output of the heating unit 22 may be adjusted.

The heating coil 223 may be supported on and fixed by the thermal insulation pad 222 in a state of being seated on an upper surface of the thermal insulation pad 222 constituting the thermal insulator 222 and 223.

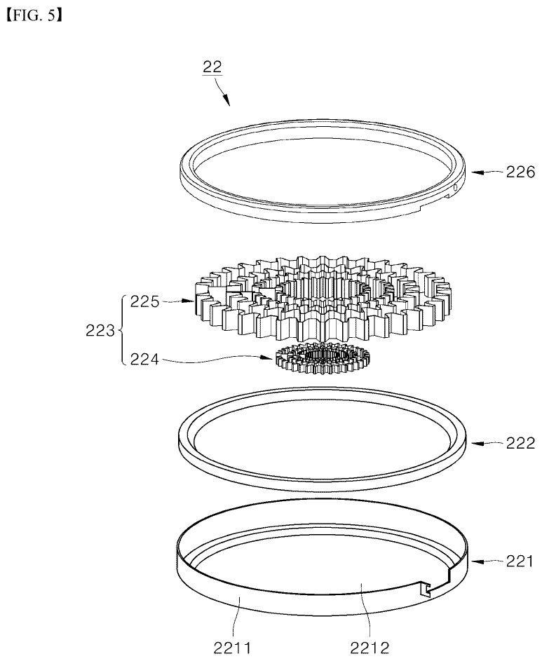

In more detail, the thermal insulator 222 and 226 may include the thermal insulation pad 222 formed in a disk shape as shown in FIG. 5.

The thermal insulation pad 222 may be disposed inside the casing 221 in a state of being entirely accommodated inside the casing 221 to be described later.

When the power is supplied to the heating coil 223, the surface temperature of the heating coil 223 may be increased to a maximum of about 2000 °C.

The thermal insulation pad 222 may be made of a non-flammable thermal insulation material to be suitable for a high-temperature environment formed by the heating coil 223.

As described above, as the heating coil 223 is seated on the upper surface of the thermal insulation pad 222 made of the non-flammable thermal insulation material, the thermal insulation pad 222 may minimize the transfer of heat in the downward direction when the heating coil 223 is heated. In addition, the heating coil 223 may be disposed on the upper surface of the thermal insulation pad 222.

In one example, the thermal insulator 222 and 226 may further include the thermal insulation ring 226 formed in a circular ring shape as shown in FIG. 5.

Like the thermal insulation pad 222, the thermal insulation ring 226 may be made of the non-flammable thermal insulation material to be suitable for a high-temperature environment formed by the heating coil 223.

In this regard, the thermal insulation ring 226 may extend along an outer edge of the thermal insulation pad 222 and may be disposed to be coupled to the outer edge of the thermal insulation pad 222.

Accordingly, as the thermal insulation ring 226 is coupled to the thermal insulation pad 222, an accommodation space S in which the heating coil 223 may be entirely accommodated may be formed radially inwardly of the thermal insulation ring 226 and on top of the thermal insulation pad 222.

In one example, an upper end of the thermal insulation ring 226 may be disposed to be in surface contact with a lower surface of the top plate 23.

In this regard, the upper end of the thermal insulation ring 226 may be maintained in a state of elastically contacting the lower surface of the top plate 23 under the pressing force of the spring 24 as described above.

Accordingly, the thermal insulation ring 226 and the top plate 23 may be effectively hermetically sealed to each other using the spring 24, and thus an amount of the heat inside the heating unit 22 discharged in a convection manner to the outside out of the heating unit 22 may be minimized.

In one example, the casing 221 is coupled to the outer surface of the thermal insulator 222 and 226 to protect the thermal insulator 222 and 226 and the heating coil 223.

The casing 221 may be formed in a cylindrical shape with an open upper surface so as to accommodate the thermal insulation pad 222 and the thermal insulation ring 226 therein and protect them.

Thus, the casing 221 may be formed by pressing a plate made of a predetermined metal material so as to be suitable for a high-temperature environment and such that the thermal insulation pad 222 and the thermal insulation ring 226 having relatively low rigidity are effectively protected by the casing 221.

Since the casing 221 is generally formed in a cylindrical shape, the casing 221 may include a disk-shaped bottom surface portion 2212 and a cylindrical side surface portion 2211 extending along the outer edge of the bottom surface portion 2212 and protruding upwards therefrom.

The cylindrical side surface portion 2211 of the casing 221 may be formed in a cylindrical shape corresponding to the shape of each of the outer circumferential surface of the thermal insulation pad 222 and the outer circumferential surface of the thermal insulation ring 226.

In this regard, the outer circumferential surface of the thermal insulation pad 222 may be entirely covered with the cylindrical side surface portion 2211, while the outer circumferential surface of the thermal insulation ring 226 may be partially covered with the cylindrical side surface portion 2211.

That is, as described above, an upper end of the cylindrical side surface portion 2211 may be positioned at a lower position in the up-down direction than that of an upper surface of the thermal insulation ring 226 so that the thermal insulation ring 226 may be formed in a surface contact state on the lower surface of the top plate 23.

Accordingly, the thermal insulation ring 226 may be exposed to the outside in an area between the upper end surface of the thermal insulation ring 226 and the upper end of the cylindrical side surface portion 2211 in the up-down direction.

The bottom surface portion 2212 of the casing 221 may include a first bottom surface 2212a connected to a lower end edge of the cylindrical side surface portion 2211 and a second bottom surface 2212b disposed radially inwardly of the first bottom surface 2212a.

As illustrated, the second bottom surface 2212b may be formed concavely in the downward direction so as to be positioned at a lower position in the up-down direction than a position of the first bottom surface 2212a.

A horizontal width of the first bottom surface 2212a may correspond to a horizontal thickness of the above-described thermal insulation ring 226, and the area size of the second bottom surface 2212b may correspond to the area size occupied with the heating coil 223.

As described above, the second bottom surface 2212b having the area size corresponding to the area size occupied with the heating coil 223 is concavely formed in the downward direction, so that a vertical height of the accommodation space S in which the heating coil 223 is seated may be increased, and as will be described later, a spare space for receiving a thermostat 2271 therein may be secured.

In one example, a fastening hole 2212h for fastening the above-described spring 24 may be formed in the first bottom surface 2212a.

One end of the spring 24 may be fastened to the fastening hole 2212h of the first bottom surface 2212a using a fastening means (not shown) such as a screw bolt.

However, as described above, the number of the springs 24 may be set to vary based on the size or the weight of the heating unit 22 In order to secure design diversity and tolerance in which the spring design may be set to vary according to the shape and weight of the heating unit 22, the plurality of fastening holes 2212h may be formed in the first bottom surface 2212a so as to be arranged in the circumferential direction, and a circumferential spacing between the fastening holes 2212h may be variously set.

In one example, the heating unit 22 may further include an overheating prevention device 227 disposed outside the casing 221.

More specifically, as illustrated in FIGS. 3 to 5, the overheating prevention device 227 may include the thermostat 2271 extending from the outside out of the casing 221 into the inner accommodation space S of the thermal insulator 222 and 226, and a housing 2272 disposed outside the casing 221.

As illustrated, the thermostat 2271 may be provided in a rod shape, and one end of the rod shape may be disposed inside the housing 2272 and the other end of the rod shape may be disposed at a center of the inner accommodation space S.

That is, while the thermostat 2271 is positioned on top of the heating coil 223, the thermostat 2271 may extend across the heating coil 223, and detect whether the accommodation space S in which the heating coil 223 is disposed is overheated.

Although not shown, a switch for controlling an electrical connection between a pair of terminals 2273 for supplying power to the heating coil 223 and the power supply is connected inside the housing 2272.

Accordingly, when overheating or overload occurs in the heating coil 223 or the accommodation space S and thus the temperature of the accommodation space S rises to a predetermined set temperature or higher, the switch disposed inside the housing 2272 is opened by the thermostat 2271, and thus the power supply to the heating coil 223 may be immediately cut off.

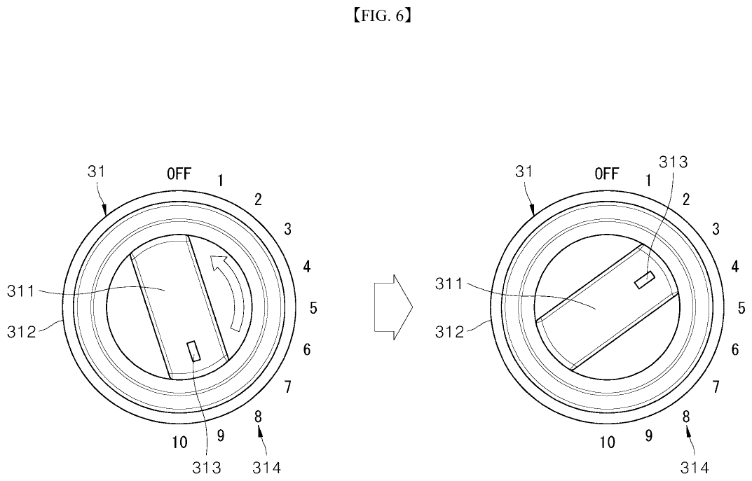

Since any means known in the art may be applied to the detailed configuration of the overheating prevention device 227, a detailed description of the detailed configuration thereof will be omitted.

[Configuration on Thermal Output Control of Heating Unit] Hereinafter, a configuration in which the cooking appliance 1 according to an embodiment of the present disclosure adjusts the thermal output of the heating unit 22 will be described with reference to FIGS. 6 to 9.

As described above, the cooktop 20 of the cooking appliance 1 according to the present disclosure may be configured to allow the user to adjust the thermal output of the heating unit 22 via a rotation manipulation on the knob 31 constituting the manipulator 30, similarly to the related art.

FIG. 6 shows an example configuration of the knob 31.

Referring to FIG. 6, the knob 31 constituting the manipulator 30 may include a knob ring 312 installed on the cooktop 20 in a fixed state, and a knob grip 311 rotatably supported by the knob ring 312.

In addition, as illustrated, a plurality of indexes capable of visually presenting heating power levels corresponding to the thermal outputs generated from the heating unit 22 to the user may be displayed around the outer circumferential surface of the knob ring 312.

FIG. 6 illustrates a configuration in which the plurality of indexes indicating heating power levels that may be generated in a range between the maximum heating power level and the minimum heating power level of the heating unit 22 are presented using an output level index 314 indicating a plurality of output levels, for example, in which the heating power level range is divided into natural number levels from a level 0 OFF to a level 10.

However, the present disclosure is not limited thereto, and as will be described below, an index may be displayed so that a heating power level that may be generated in the range between the maximum heating power level and the minimum heating power level of the heating unit 22 may be selected in another manner. In the following description, the output level index 314 in which the heating power level range is divided into the natural number levels from the level 0 OFF to the level 10 will be described.

In addition, as illustrated, a reference index 313 for displaying the currently selected heating power level may be displayed on the knob grip 311.

The user may adjust the thermal output of the heating unit 22 by rotating the knob grip 311 to rotate the reference index 313 to a desired heating power level.

In order to cook the food by heating the container using the cooktop 20, as illustrated in FIG. 6, the user may start cooking by rotating the knob grip 311 to select the heating power level which may be output from the heating unit 22.

In this regard, generally, in order to rapidly increase the temperature of the cold food, the heating power level of the heating unit 22 may be selected as a level 9 or the level 10 corresponding to a relatively high heating power level at the starting point of cooking.

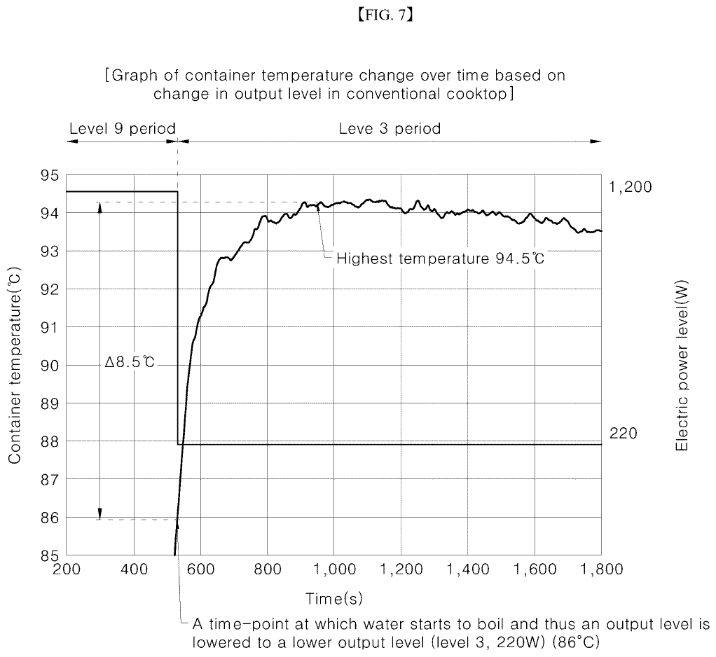

FIG. 7 illustrates a graph of recording a result of measuring the temperature of the container over time duration from a time-point at which the heating of the container is started in a state in which an initial heating power level (hereinafter, referred to as a first selected heating power level) of the heating unit 22 is selected as the level 9, according to the related art.

Referring to FIG. 7, the first selected heating power level of the heating unit 22 is set to the level 9. Thus, the food inside the container starts to boil at a time-point at which about 500 seconds have elapsed from the time-point at which the heating of the container has started.

When, as described above, the temperature of the container increases and the food starts to boil, the user rotates the knob grip 311 to adjust the heating power level of the heating unit 22 to a low heating power level in order to prevent the food from overflowing from the container or the food from being excessively cooked (overcook). In this regard, the adjusted heating power level of the heating unit 22 may be referred to as a second selected heating power level to be distinguished from the above-described first selected heating power level.

For example, as illustrated in FIG. 7, the second selected heating power level of the heating unit 22 may be changed and set to a level 3 at a time-point at which the food starts to boil.

However, unlike a cooktop of a different type, in the cooktop 20 including the radiant type heater, even when the heating power level of the heating unit 22 is changed from the level 9 as the first selected heating power level to the level 3 as the second selected heating power level, the temperature of the container is not immediately lowered due to the thermal capacity and thermal inertia of the cooktop 20 itself including the heating unit 22 and the top plate 23, but rather the temperature of the container is increased.

That is, as shown in FIG. 7, it may be identified that although the thermal output of the heating unit 22 is adjusted so that the heating power level of the heating unit 22 is changed to the second selected heating power level corresponding to the level 3 as a relatively low heating power level, at the time-point at which the food starts to boil (after about 500 seconds have elapsed), the temperature of the container does not decrease, but rather rapidly increases until a time-point at which 900 seconds have elapsed, and the temperature of the container records the highest temperature at the time-point at which the 900 seconds have elapsed.

In addition, it may be identified that the temperature of the container decreases after the time-point at which the 900 seconds have elapsed and at which the temperature of the container records the highest temperature, but the rate of the temperate decrease over time duration is maintained very low. That is, as shown, it may be identified that the temperature of the container is maintained at approximately 92 °C or higher for a duration from the time-point at which the 900 seconds have elapsed and at which the temperature of the container records the highest temperature to a time-point at which 1800 seconds have elapsed.

As described above, although the thermal output of the heating unit 22 is adjusted to the second selected heating power level as the low heating power level, the temperature of the container does not decrease to the temperature corresponding to the second selected heating power level as the lower heating power level, but rather the temperature of the container continuously increases, so that unintended overcooking may occur on the food stored in the container.

In addition, even after the thermal output of the heating unit 22 is adjusted to the second selected heating power level as the low heating power level, the temperature of the container is continuously increased. In this regard, the thermal output corresponding to the second selected heating power level is to be continuously generated. This may lead to power loss, thereby causing deterioration of power efficiency of the heating coil.

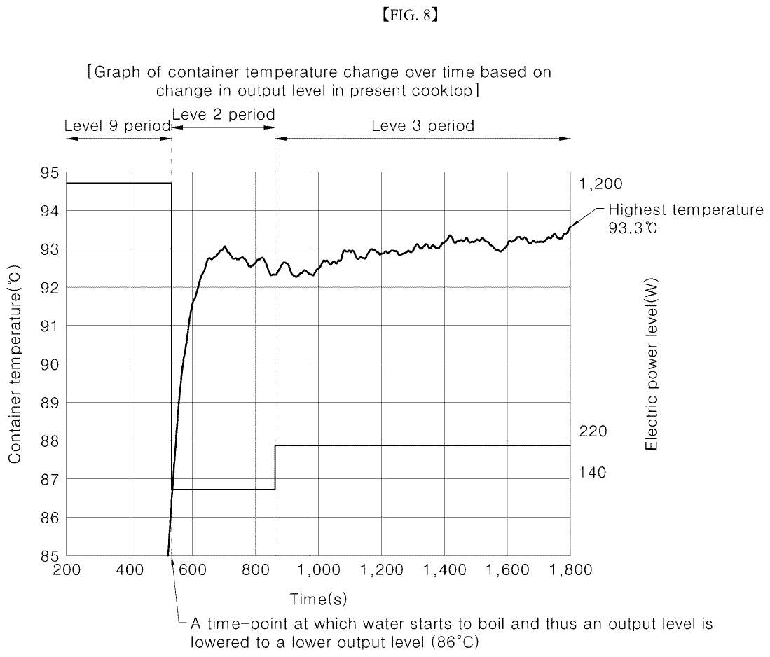

FIG. 8 illustrates a graph of recording a result of measuring the temperature of a container over time duration when a configuration for adjusting the thermal output of the heating unit 22 constituting the cooktop 20 of the cooking appliance 1 according to an embodiment of the present disclosure is applied.

The graph shown in FIG. 8 shows a result of the experiment performed using the heating unit 22 having the same maximum thermal output as in FIG. 7 and on the container of the same size in which the food of the same capacity is stored as in FIG. 7, for comparison with the graph shown in FIG. 7.

Referring to FIG. 8, in the configuration of adjusting the thermal output of the heating unit 22 constituting the cooktop 20 of the cooking appliance 1 according to the embodiment of the present disclosure, the first selected heating power level of the heating unit 22 is set to the level 9, and then the heating of the container is started, in a similar manner to the above-described configuration.

In a similar manner to the above-described configuration, the first selected heating power level of the heating unit 22 is set to the level 9, and the food inside the container starts to boil at a time-point at which approximately 500 seconds have elapsed from the time-point at which the heating of the container is started.

When the temperature of the container increases such that the food starts to boil, the knob grip 311 is rotated to change the thermal output of the heating unit 22 to the second selected heating power level of the level 3 as the lower heating power level in order to prevent overflowing of the food from the container or overcooking of the food.

However, unlike the above-described configuration, the cooktop 20 of the cooking appliance 1 according to an embodiment of the present disclosure may be configured to supply the electric power level corresponding to a heating power level lower than the second selected heating power level to the heating coil 223 so as to generate a thermal output lower than the level 3 rather than the second selected heating power level as the selected level 3.

That is, as shown in FIG. 8, not the electric power level corresponding to the level 3 heating power level 200 W as the second selected heating power level but the electric power level corresponding to the level 2 heating power level 120 W lower than the level 3 heating power level 200 W as the second selected heating power level is supplied to the heating coil 223, so that the reduced thermal output is generated in the heating unit 22.

In this regard, the reduced power to generate the thermal output reduced to the level 2 heating power level may be supplied during a predetermined set time duration, and as illustrated in FIG. 8, the predetermined set time duration may be, for example, in a range of 4.5 minutes to 5.5 minutes, preferably 5 minutes.

After the predetermined set time duration has elapsed, the electric power level corresponding to the heating power level of the level 3 as the second selected heating power level as actually selected may be supplied as illustrated in FIG. 8.

It may be identified that as described above, the electric power level corresponding to the heating power level of the level 2 which is lower by one level than the second selected heating power level of the level 3, is supplied to the heating coil 223 of the heating unit 22 for the predetermined set time duration, such that as shown in FIG. 8, the temperature of the container tends to increase due to the heat capacity and the thermal inertia of the cooktop 20, but the overall temperature of the container is maintained at a lower value than that in the graph shown in FIG. 7.

In addition, unlike the above description, a time duration taken to reach the maximum temperature of the container may be increased to 1800 seconds. That is, a time-point at which the temperature of the container reaches the highest temperature may be delayed.

As described above, in the cooktop 20 of the cooking appliance 1 according to an embodiment of the present disclosure, as the temperature of the container is kept much lower over the entire period, compared to the conventional configuration shown in FIG. 7, thereby minimizing unnecessary power loss. Further, the time-point at which the temperature of the container reaches the highest temperature may be delayed, thereby effectively preventing unintended overcooking of the food stored inside the container.

However, the configuration illustrated in FIG. 8 is merely an example, and a configuration in which when the user uses the manipulator to switch the current heating power level from the first selected heating power level as the high heating power level to the second selected heating power level as the low heating power level, the electric power level corresponding to the heating power level lower than the second selected heating power level is supplied to the heating unit may be variously modified and applied.

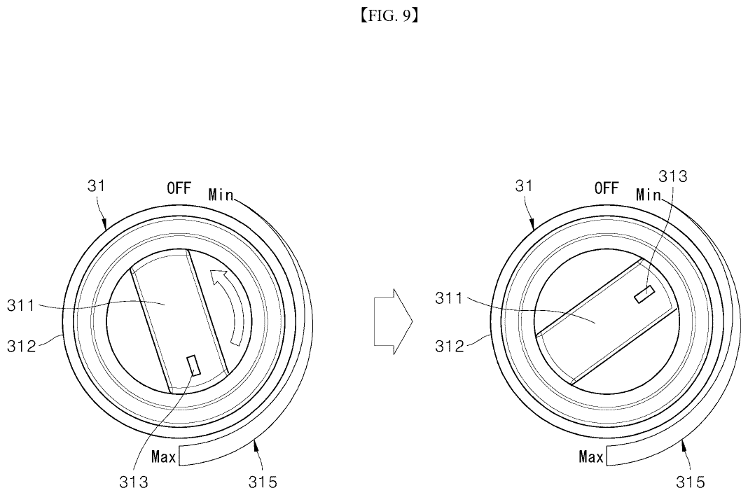

For example, the above configuration may be applied to a case of the cooktop 20 including a configuration as illustrated in FIG. 9 in which the output level index 315 indicating the thermal output of the heating unit 22 is changed not in a step-by-step manner but in a continuous manner in a range between the lowest heating power level and the highest heating power level.

### Configuration of Controller and Control Method

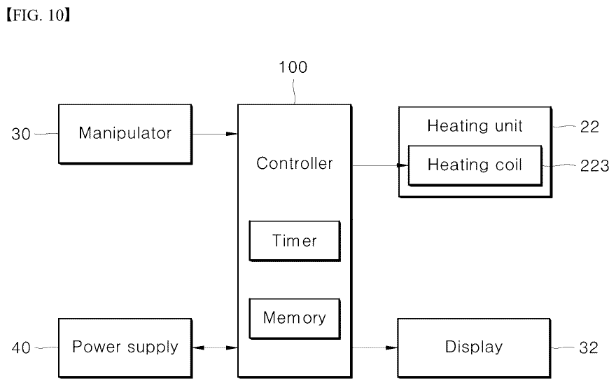

Hereinafter, a configuration of a controller 100 constituting the cooktop 20 of the cooking appliance 1 according to an embodiment of the present disclosure and a control method S1 for controlling the cooking appliance using the controller will be described with reference to FIG. 10.

As shown in FIG. 10, the cooking appliance 1 according to the embodiment of the present disclosure may include the controller 100 for controlling each of function modules.

The controller 100 may be provided in various forms such as a microcontroller, a microcomputer, or a microprocessor, as known in the art.

First, the controller 100 may be electrically connected to the manipulator 30 to which a user's manipulation is input. When a user's power on/off manipulation input and a user's heating power level selection manipulation are input through the manipulator 30, the manipulator 30 may transmit an electrical signal corresponding thereto to the controller 100.

When the controller 100 receives the electrical signal from the manipulator 30, the controller 100 may control the power supply 40 to turn on/off the electric power of the cooking appliance 1 or to supply an electric power level corresponding to the selected heating power level to the heating coil 223 of the heating unit 22.

In one example, the controller 100 may be electrically connected to a memory and a timer. The controller 100 may retrieve information regarding a first set heating power level PL_set1 and a second set heating power level PL_set2 as a reference of a configuration for supplying an electric power level lower than the electric power level corresponding to the second selected heating power level PL_sel2 as stored in the memory, as described below, and generate a control signal for setting and changing the heating power level of the heating unit 22 using the retrieved information.

Furthermore, as will be described later, the memory may further store therein information on a first set time duration t1, a second set time duration t2, a third set time duration t3, and a fourth set time duration t4 as a time duration condition for which an electric power level lower than an electric power level corresponding to the second selected heating power level PL_sel2 is supplied to the heating unit.

In addition, the controller 100 may measure an elapsed time duration after the supply of an electric power level corresponding to the first selected heating power level PL_sell to the heating coil 223 is started, and an elapsed time duration after the supply of the electric power level lower than the electric power level corresponding to the second selected heating power level PL_sel2 to the heating coil 223 is started, using a timer, and may determine whether to switch to the second selected heating power level PL_sel2 based on a comparing result of the measured elapsed time duration with the condition related to the first set time duration t1, the second set time duration t2, the third set time duration t3, and the fourth set time duration t4 pre-stored in the memory.

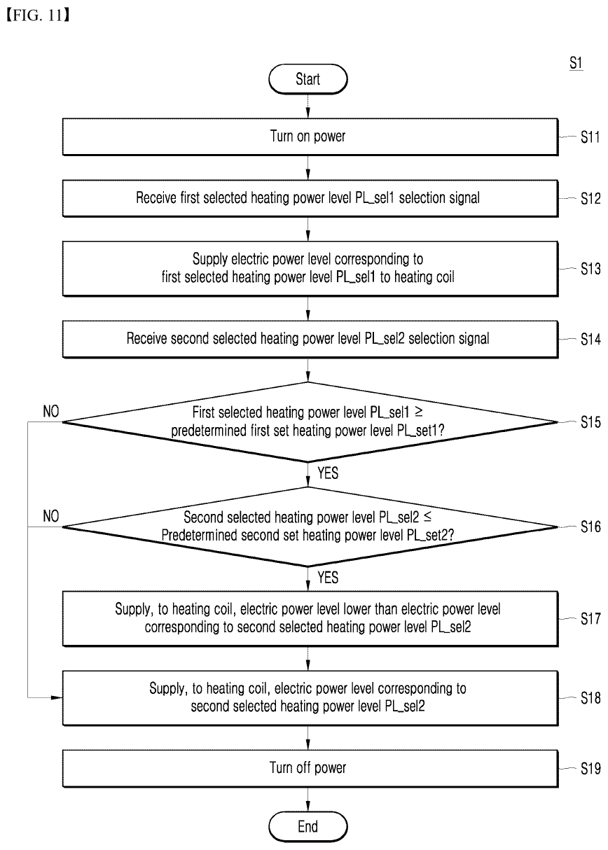

Hereinafter, a control method for controlling the cooking appliance 1 according to the present disclosure will be described with reference to FIGS. 11 to 15.

FIG. 11 illustrates respective steps constituting the control method S1 of the cooktop 20 of the cooking appliance 1 according to an embodiment of the present disclosure.

Referring to FIG. 11, when an electric power turn-on manipulation is input through the manipulator 30 from the user, the cooktop 20 may be turned on while the electric power is supplied thereto through the power supply 40. (S11) After the electrical power of the cooktop 20 is turned on in step S11, the controller 100 may receive a first selected heating power level PL_sel1 selection signal corresponding to the thermal output of the heating unit 22 desired by the user through the manipulator 30. (S12) When the selection signal of the first selected heating power level PL_sel1 is received from the manipulator 30 in step S12, the controller 100 supplies an electric power level corresponding to the first selected heating power level PL_sel1 to the heating coil 223 through the power supply 40 to start the operation of the heating unit 22. (S13) After the operation of the heating unit 22 at the first selected heating power level PL_sel1 is started in step S13, when the user inputs a manipulation of changing the thermal output of the heating unit 22 to the second selected heating power level PL_sel2 through the manipulator 30, the controller 100 may receive a second selected heating power level PL_sel2 selection signal through the manipulator 30. (S14) As described above, when the selection signal of the second selected heating power level PL_sel2 is received through the manipulator 30 in step S14, the controller 100 determines whether the first selected heating power level PL_sel1 exceeds the predetermined first set heating power level PL_set1 and whether the second selected heating power level PL_sel2 exceeds the predetermined second set heating power level PL_set2. (S15, S16) That is, as described above, the cooktop 20 of the cooking appliance 1 according to an embodiment of the present disclosure may be configured as follows. In response to that a user manipulation of changing the thermal output of the heating unit 22 to the low heating power level is input while the cooktop is heating the container at the high heating power level, the cooktop 20 may supply an electric power level corresponding to a heating power level lower than the selected low heating power level in order to prevent overcooking of food and unnecessary power loss that may occur due to excessive difference between the current high heating power level and the selected low heating power level.

As described above, a reference for determining whether the first selected heating power level PL_sel1 is a relatively high heating power level may be the first set heating power level PL_set1, and a reference for determining whether the second selected heating power level PL_sel2 is a relatively low heating power level may be the second set heating power level PL_set2.

Each of the first set heating power level PL_set1 and the second set heating power level PL_set2 may be set based on the maximum heating power levels that the heating units 22 may respectively generate.

This is because the maximum heating power levels and thus the maximum thermal outputs which the respective heating units 22 may generate may be set to be different from each other.

In consideration of this fact, the first set heating power level PL_set1 may be set to be 55% to 65% of the maximum heating power level or the maximum thermal output of the heating unit 22, and preferably, may be set to 60% of the maximum heating power level or the maximum thermal output of the heating unit 22.

In addition, the second set heating power level PL_set2 may be set to a maximum heating power level or a range of 35% to 45% of the maximum thermal output, and preferably, may be set to be 40% of the maximum heating power level or the maximum thermal output of the heating unit 22.

Accordingly, upon determination that the first selected heating power level PL sell is smaller than the first set heating power level PL_set1 in step S15 or upon determination that the second selected heating power level PL_sel2 is greater than or equal to the second set heating power level PL_set2 in step S16, the controller 100 may supply an electric power level corresponding to the second selected heating power level PL_sel2 actually selected by the user to the heating coil 223 through the power supply 40.

In such cases, the difference between the first selected heating power level PL sell and the second selected heating power level PL_sel2 is relatively small, and thus it may be determined that the user does not intend to significantly lower the thermal output of the heating unit 22 and does not intend to significantly lower the temperature of the container.

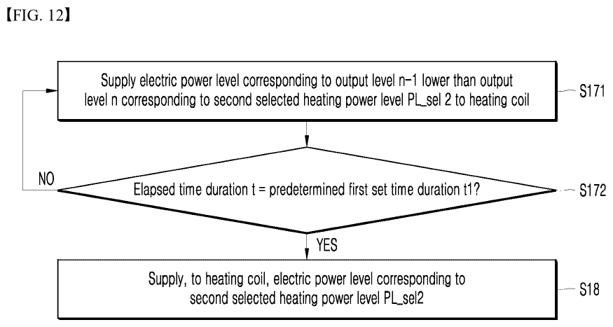

On the contrary, upon determination that the first selected heating power level PL_sel1 is greater than or equal to the first set heating power level PL_set1 in step S15 and the second selected heating power level PL_sel2 is smaller than the second set heating power level PL_set2 in step S16, the controller 100 may supply, to the heating coil 223, an electric power level lower than an electric power level corresponding to the second selected heating power level PL_sel2 actually selected by the user through the power supply 40 in order to prevent the overcook and power consumption as described above. (S17) FIGS. 12 to 15 illustrate detailed steps of S17, and an embodiment of a configuration for supplying an electric power level lower than an electric power level corresponding to the second selected heating power level PL_sel2 is illustrated.

First, referring to FIG. 12, according to a first embodiment, the step of supplying the electric power level lower than the electric power level corresponding to the second selected heating power level PL_sel 2 to the heating coil 223 may include the step of supplying the electric power level corresponding to the output level n-1 lower than the output level n corresponding to the second selected heating power level PL_sel 2 to the heating coil 223 in S171.

As described above, the step S171 may be applied to a case in which a heating power level range that may be generated between the maximum heating power level and the minimum heating power level of the heating unit 22 is divided into a plurality of output levels, for example, a natural number of levels from the level 0 OFF to the level 10.

In this regard, for example, the output level lower than the output level n corresponding to the second selected heating power level PL_sel2 may be the output level lower by one level than the output level n corresponding to the second selected heating power level PL_sel2.

Therefore, when the output level corresponding to the second selected heating power level PL_sel2 is the level 3, in step S171, the electric power level corresponding to the level 2 may be actually supplied to the heating coil 223.

In addition, according to the first embodiment, the step of supplying the electric power level lower than the electric power level corresponding to the second selected heating power level PL_sel2 to the heating coil 223 may further include a step S172 of determining whether the elapsed time duration t from the time-point at which the electric power level corresponding to the output level lower than the output level of the second selected heating power level is supplied to the heating coil 223 reaches a predetermined first set time duration t1 in the step S171.

The predetermined first set time duration t1 may be in a range of 4.5 minutes to 5.5 minutes, preferably 5 minutes, in consideration that the maximum thermal outputs of the heating units 22 may be set to be different from each other.

Upon determination in the step S172 that the elapsed time duration t has reached the predetermined first set time duration t1, the controller 100 proceeds to step S18 and changes the power level to be supplied to the heating coil 223 into the electric power level corresponding to the second selected heating power level PL_sel2.

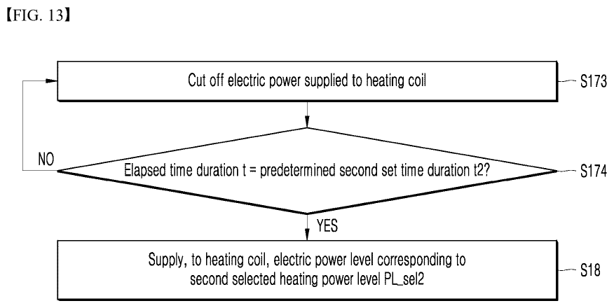

In one example, FIG. 13 illustrates a detailed configuration of a step of supplying an electric power level lower than an electric power level corresponding to the second selected heating power level PL_sel2 to the heating coil 223 according to a second embodiment.

Referring to FIG. 13, according to the second embodiment, the step of supplying the electric power level lower than the electric power level corresponding to the second selected heating power level PL_sel 2 to the heating coil 223 may include a step S173 of cutting off the electric power supplied to the heating coil 223.

That is, the power supplied to the heating coil 223 through the power supply 40 is cut off to turn off the operation of the heating unit 22.

As described above, in the step S173, the power supplied to the heating coil 223 is cut off and the operation of the heating unit 22 is turned off, thereby further improving the effect of preventing the overcook and the power consumption.

In addition, according to the second embodiment, the step of supplying the electric power level lower than the electric power level corresponding to the second selected heating power level PL_sel 2 to the heating coil 223 may further include a step S174 of determining whether the elapsed time duration t from a timing of cutting off the electric power supplied to the heating coil 223 reaches a predetermined second set time duration t2 in the step S173.

The predetermined second set time duration t2 may be in a range of 2.5 minutes to 3.5 minutes, preferably 3 minutes, in consideration that the maximum thermal outputs of the different heating units 22 may be set to be different from each other. That is, the second set time duration t2 may be selected to be shorter than the first set time duration t1 described above in consideration of the state in which the power is completely cut off.

Upon determination in the step S174 that the elapsed time duration t has reached the predetermined second set time duration t2, the controller 100 proceeds to step S18 and changes the power level supplied to the heating coil 223 into the electric power level corresponding to the second selected heating power level PL_sel2.

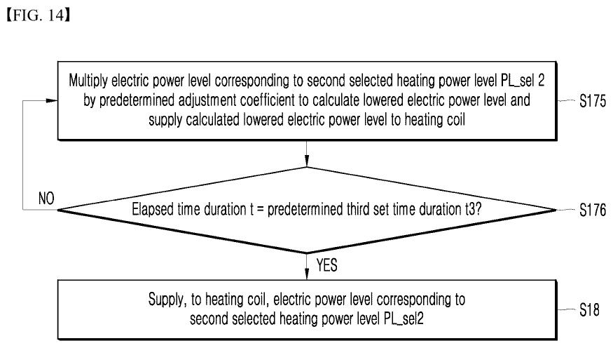

In one example, FIG. 14 illustrates a detailed configuration of a step of supplying an electric power level lower than an electric power level corresponding to the second selected heating power level PL_sel2 to the heating coil 223 according to a third embodiment.

Referring to FIG. 14, according to the third embodiment, the step of supplying the electric power level lower than the electric power level corresponding to the second selected heating power level PL_sel 2 to the heating coil 223 may include a step S175 of multiplying the electric power level corresponding to the second selected heating power level PL_sel 2 by a predetermined adjustment coefficient K to calculate a lowered electric power level and of supplying the calculated lowered electric power level to the heating coil 223.

As described above, the step S175 may be applied to a case in which the heating power level of the heating unit 22 is selected not in a step-by-step manner but in a continuous manner between the lowest heating power level and the highest heating power level, and thus the output level index 315 is displayed not in a step-by-step manner but in a continuous manner.

Therefore, even when the second selected heating power level PL_sel2 is a heating power level between the lowest heating power level and the highest heating power level and is an arbitrary heating power level smaller than or equal to the second set heating power level PL_set2 as described above, the electric power level corresponding to the arbitrary second selected heating power level PL_sel2 is multiplied by the predetermined adjustment coefficient K to calculate the lowered electric power level which in turn is supplied to the heating coil 223, so that the thermal output generated from the actual heating unit 22 may be lowered.

In this regard, the predetermined adjustment coefficient K may be in a range of 0.48 to 0.52, preferably 0.5, in consideration of that the maximum thermal outputs of the heating units may be set to be different from each other. That is, the thermal output that is reduced to 1/2 of the second selected heating power level PL_sel 2 may be generated from the heating unit 22.

In addition, according to the third embodiment, the step of supplying the electric power level lower than the electric power level corresponding to the second selected heating power level PL_sel 2 to the heating coil 223 may further include a step S176 of determining whether the elapsed time duration t from a time-point which the electric power level obtained by multiplying the electric power level corresponding to the second selected heating power level PL_sel 2 by the predetermined adjustment coefficient K starts to be supplied to the heating unit reaches the predetermined third setting time duration t 3 in step S175.

The predetermined third set time duration t3 may be in a range of 3.5 minutes to 4.5 minutes, preferably 4 minutes, in consideration that the maximum thermal outputs of the heating units may be set to be different from each other. That is, the third set time duration t3 may be selected to be smaller than the first set time duration t1 but to be larger than the second set time duration t2.

Upon determination in the step S176 that the elapsed time duration t has reached the predetermined third set time duration t3, the controller 100 proceeds to step S18 and changes the electric power level supplied to the heating coil 223 into the electric power level corresponding to the second selected heating power level PL_sel2.

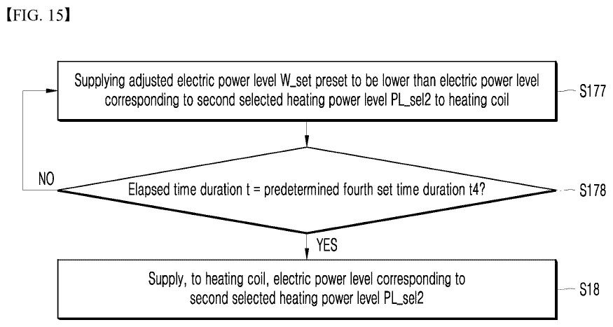

In one example, FIG. 15 illustrates a detailed configuration of a step of supplying an electric power level lower than an electric power level corresponding to the second selected heating power level PL_sel2 to the heating coil 223 according to a fourth embodiment.

Referring to FIG. 14, according to the fourth embodiment, the supplying of the electric power level lower than the electric power level corresponding to the second selected heating power level PL_sel2 to the heating coil 223 may include supplying an adjusted electric power level W_set preset to be lower than the electric power level corresponding to the second selected heating power level PL_sel2 to the heating coil 223 (S177).

That is, the adjusted electric power level W_set always having a predetermined value and based on stored information may be supplied to the heating coil 223 through the power supply 40.

In this regard, the adjusted electric power level W_set may be in a range of 180W to 220W, preferably 200 W, in consideration of that the maximum thermal outputs of the heating units may be set to be different from each other.

In addition, according to the fourth embodiment, the step of supplying the electric power level lower than the electric power level corresponding to the second selected heating power level PL_sel 2 to the heating coil 223 may further include a step S178 of determining whether the elapsed time duration t from a time-point at which the preset adjusted electric power level W_set lower than the electric power level corresponding to the second selected heating power level PL_sel 2 starts to be supplied to the heating coil 223 reaches the predetermined fourth set time duration t4 in the step S177.

The predetermined fourth set time duration t4 may be in a range of 3 minutes to 4 minutes, preferably 3.5 minutes, in consideration that the maximum thermal outputs of the heating units may be set to be different from each other. That is, although the predetermined fourth set time duration t4 may be set to be shorter than the third set time duration t3 and to be greater than the second set time duration t2.

Upon determination in the step S178 that the elapsed time duration t has reached the predetermined fourth set time duration t4, the controller 100 proceeds to step S18 and converts the electric power level supplied to the heating coil 223 into the electric power level corresponding to the second selected heating power level PL_sel2.

As described above, when the heating unit 22 continues to operate at the second selected heating power level PL_sel2 in the step S18 and then the electric power turn-off manipulation is input through the manipulator 30 by the user, the controller 100 may cut off the electric power supply through the power supply 40 and the cooktop 20 may be turned off. (S19) Although the present disclosure has been described above with reference to the drawings as illustrated in the present disclosure, the present disclosure is not limited by the embodiments and drawings disclosed in the present disclosure, and it is obvious that various modifications may be made by a person skilled in the art within the scope of the technical idea of the present disclosure. In addition, even though an effect of a configuration of the present disclosure is not explicitly described in describing the embodiment of the present disclosure above, it is obvious that the predictable effect from the configuration should be recognized.

1. A cooking appliance comprising:
a heating unit including a heating coil configured to generate heat in an electric resistance manner upon receiving electric power; and
a controller configured to control the electric power to be supplied to the heating coil,
wherein the controller is configured to:
supply an electric power level corresponding to a first selected heating power level to the heating coil such that an operation of the heating unit is started; and
in response to receiving a switching signal of an operation of the heating unit for switching the first selected heating power level to a second selected heating power level lower than the first selected heating power level, supply an electric power level lower than an electric power level corresponding to the second selected heating power level to the heating coil.

2. The cooking appliance of claim 1, wherein the controller is further configured to:
before supplying the electric power level lower than the electric power level corresponding to the second selected heating power level to the heating coil,
determine whether the first selected heating power level exceeds a predetermined first set heating power level; and
upon determination that the first selected heating power level is greater than or equal to the predetermined first set heating power level, determining whether the second selected heating power level exceeds a predetermined second set heating power level.

3. The cooking appliance of claim 2, wherein the controller is further configured to:
upon determining that the second selected heating power level is lower than or equal to the predetermined second set heating power level, supply the electric power level lower than the electric power level corresponding to the second selected heating power level to the heating coil.

4. The cooking appliance of claim 2, wherein the controller is further configured to:
upon determination that the first selected heating power level is lower than the predetermined first set heating power level, supply the electric power level corresponding to the second selected heating power level to the heating coil.

5. The cooking appliance of claim 1, wherein the controller is further configured to divide a heating power range of the heating coil from a maximum heating power level to a minimum heating power level into a plurality of output levels, and to supply an electric power level corresponding to one selected from among the plurality of output levels,
wherein the supplying of the electric power level lower than the electric power level corresponding to the second selected heating power level to the heating coil includes:
supplying, to the heating coil, an electric power level corresponding to an output level lower than the output level of the second selected heating power level.

6. The cooking appliance of claim 5, wherein the output level lower than the output level of the second selected heating power level is lower by one level than the output level of the second selected heating power level.

7. The cooking appliance of claim 5, wherein the supplying of the electric power level lower than the electric power level corresponding to the second selected heating power level to the heating coil further includes:
determining whether an elapsed time duration from a time-point at which the electric power level corresponding to the output level lower than the output level of the second selected heating power level starts to be supplied to the heating coil reaches a predetermined first set time duration.

8. The cooking appliance of claim 7, wherein the controller is further configured to:
upon determination that the elapsed time duration has reached the predetermined first set time duration,
supply the electric power level corresponding to the second selected heating power level to the heating coil.

9. The cooking appliance of claim 1, wherein the supplying of the electric power level lower than the electric power level corresponding to the second selected heating power level to the heating coil includes:
cutting off the electric power supplied to the heating coil.

10. The cooking appliance of claim 9, wherein the supplying of the electric power level lower than the electric power level corresponding to the second selected heating power level to the heating coil further includes:
determining whether an elapsed time duration from a time-point at which the electric power supplied to the heating coil is cut off reaches a predetermined second set time duration.

11. The cooking appliance of claim 10, wherein the controller is further configured to:
upon determination that the elapsed time duration has reached the predetermined second set time duration,
supply the electric power level corresponding to the second selected heating power level to the heating coil.

12. The cooking appliance of claim 1, wherein the supplying of the electric power level lower than the electric power level corresponding to the second selected heating power level to the heating coil further includes:
multiplying the electric power level corresponding to the second selected heating power level by a predetermined adjustment coefficient to calculate a lowered electric power level and supplying the calculated lowered electric power level to the heating coil; and
determining whether an elapsed time duration from a time-point at which the lowered electric power level starts to be supplied to the heating coil reaches a predetermined third set time duration,
wherein the controller is further configured to:
upon determination that the elapsed time duration has reached the predetermined third set time duration, supply the electric power level corresponding to the second selected heating power level to the heating coil.

13. The cooking appliance of claim 1, wherein the supplying of the electric power level lower than the electric power level corresponding to the second selected heating power level to the heating coil includes:
supplying, to the heating coil, an adjusted electric power level preset to be lower than the electric power level corresponding to the second selected heating power level.

14. The cooking appliance of claim 13, wherein the supplying of the electric power level lower than the electric power level corresponding to the second selected heating power level to the heating coil further includes:
determining whether an elapsed time duration from a time-point at which the adjusted electric power level starts to be supplied to the heating coil reaches a predetermined fourth set time duration.

15. The cooking appliance of claim 14, wherein the controller is further configured to:
upon determination that the elapsed time duration has reached the predetermined fourth set time duration,
supply the electric power level corresponding to the second selected heating power level to the heating coil.
